(19) United States
(12) Patent Application Publication
(10) Pub. No.: US 2009/0020236 A1
(43) Pub. Date: Jan. 22, 2009

(54) Shading roller blind having a roller blind lock

(76) Inventor: Melf Hansen, Gondelsheim (DE)

Correspondence Address: FLYNN THIEL BOUTELL & TANIS, P.C., 2026 RAMBLING ROAD, KALAMAZOO, MI, 49008-1631, US

(21) Appl. No.: 12/218,847

(22) Filed: Jul. 18, 2008

(30) Foreign Application Priority Data
Jul. 20, 2007 (DE) 102007035043.2

(51) Int. Cl. E06B 9/42

(52) U.S. Cl. 160/275; 160/293.1; 160/294

(57) ABSTRACT

The invention relates to a shading roller blind for a motor vehicle window, with a flexible sheetlike structure (40) which can be wound up on and unwound from a winding shaft (43) and can be moved with the aid of at least one linear guide means (5, 105) from a stowed position into an at least partially unwound protective position, and with a releasable blocking device (7) by means of which the linear guide means (5, 105) can be arrested in at least one position, in particular the protective position and/or stowed position, the blocking device (7) comprising a push-push lock.

The invention relates to a shading roller blind for a motor vehicle window, with a flexible sheetlike structure which can be wound up on and unwound from a winding shaft and can be moved with the aid of at least one linear guide means from a stowed position into an at least partially unwound protective position.

Shading roller blinds can be provided on rear windows, side windows and/or wraparound windows of vehicles. The flexible sheetlike structure, also referred to as the roller blind web, is made from a suitable material in accordance with requirements. In order to unwind the flexible sheetlike structure from the winding shaft, it is known, for example, at a free end of the flexible sheetlike structure to connect a pull-out bar or pull-out profile to the flexible sheetlike structure, said pull-out bar preferably extending over the entire width of the sheetlike structure. The pull-out bar or the pull-out profile can be moved by suitable means, for example scissor-type or pivoting arms, buckleproof antennae, racks guided in guide rails, or central telescopic arms. Said linear guide means are driven, for example, electrically, pneumatically and/or hydraulically.

It is furthermore known, for example from DE 201 129 48 U1, to provide a manually releasable blocking device, by means of which a linear guide means can be arrested in a stowed position or protective position, wherein, after the blocking device is released, a mechanical drive means is effective such that the flexible sheetlike structure is unwound from the winding shaft. The blocking device can be released by means of releasing a push button, with a switch necessary for this purpose being integrated, for example, in a door trim panel. The linear guide means embodied as an antenna is arranged, for example, in the wet region of the vehicle door on account of the construction space required. The linear guide means and the switch are coupled to each other via a Bowden cable or the like.

It is the object of the invention to provide a shading roller blind which permits comfortable and reliable operation using simple means.

This object is achieved by a shading roller blind for a motor vehicle window, with a flexible sheetlike structure which can be wound up on and unwound from a winding shaft and can be moved with the aid of at least one linear guide means from a stowed position into an at least partially unwound protective position, and with a releasable blocking device by means of which the linear guide means can be arrested at least in one position, in particular the protective position and/or the stowed position, with the blocking device comprising a push-push lock.

The push-push lock referred to here is an actuating mechanism which operates in accordance with a “compression-activated ballpoint pen principle”. In this case, the blocking device is locked and released by application of a force always in the same actuating direction and/or by means of a movement corresponding to the force. This force is generally a compressive force. By means of the push-push lock, for example, the roller blind web is prevented from being pulled out or unwound. In another refinement, the blocking device locks a winding-up action of the roller blind web.

In a refinement of the invention, the linear guide means can be arrested in the stowed position, with it being possible for the blocking device to be released by application of a force, in particular a compressive force, to the linear guide means and/or movement of the linear guide means counter to an unwinding direction. In other words, in order to release the blocking device and unwind the roller blind web, a compressive force is preferably applied counter to a tensile force necessary for the unwinding action. In this case, the resetting force necessary for the winding-up action can be used for the locking. The release or locking force can preferably be applied in a simple manner by pressing on the linear guide means and/or on parts thereof counter to the unwinding direction. However, it is also conceivable to provide force deflecting means such that a user applies a tensile force but this acts as a compressive force for the push-push lock. A push-push lock enables switching elements or the like which have to be integrated, for example, on an inner trim panel of a side door to be omitted. A mechanical outlay on the designing of a push-push lock is low, and therefore a cost-effective shading roller blind is created. In one refinement in this connection, the blocking device is at least partially arranged on a housing or the like of the winding shaft, with it being possible for the shading roller blind according to the invention to be designed as a compact constructional unit which can be assembled and tested in a preassembly stage. The tested unit can be installed as a component in a motor vehicle. In order to unwind the roller blind web, use can be made of any desired linear guide means, for example lateral guide rails, pivoting arms and/or centrally arranged actuating rods are conceivable.

In one refinement of the shading roller blind, a mechanical drive means which is effective in the unwinding direction is provided, by means of which, after the blocking device is released, the flexible sheetlike structure can be unwound from the winding shaft. Since the drive means is effective only in one direction, namely the unwinding direction, a corresponding arrangement is also referred to as a semiautomatic mechanism. In one refinement, the flexible sheetlike structure is wound up manually, with a restoring spring or the like preferably being provided on the winding shaft and ensuring that the flexible sheetlike structure is rolled up onto the winding shaft in a compact manner.

In a further refinement of the shading roller blind, the mechanical drive means is designed as a spring-loaded arrangement. Depending on the orientation, the spring-loaded arrangement comprises a compression spring, for example a helical compression spring, or a tension spring. The flexible sheetlike structure is wound up counter to the action of the spring, with the force stored in this manner acting on the linear guide means in order to unwind the flexible sheetlike structure.

In a further refinement of the shading roller blind, the blocking device comprises at least one latching element which interacts with the linear guide means so as to arrest it. Depending on the design of the linear guide means, a mating latching element can be arranged on the pull-out profile or on other elements. In other refinements, a latching element is provided on the linear guide means.

In a development of the shading roller blind, the linear guide means comprises a guide with a guide groove in which the latching element is guided, the guide groove having at least one latching point. The latching point is designed in a complementary manner to the latching element such that the latter can be latched in place there. In one refinement, the latching element is mounted on the blocking device in a manner such that it is displaceable transversely with respect to the unwinding direction, in particular at right angles thereto. Particularly advantageous options for the design of the guide groove arise as a result.

In a development of the shading roller blind, the guide groove is in the shape of a cardioid at least in some sections. Such a shape has proven particularly advantageous for the realization of a push-push lock.

In another refinement of the shading roller blind, a blocking device is alternatively or additionally provided with a push-push lock, the actuating direction of which runs transversely with respect to the unwinding direction, in particular at an angle of approx. 90° with respect thereto. In this case, an actuating switch or push button can be provided, with locking and/or unlocking being possible by pressing the push button. The shading roller blind is preferably equipped with a semiautomatic mechanism. In one refinement of the invention, a restoring spring is provided, with it being possible for the roller blind web to be extended manually counter to the force of the restoring spring and for it to be locked in any desired extended position, in particular in a protective position. By release of the blocking device, the roller blind web is automatically retracted by means of the force of the restoring spring. In another refinement, a drive means which is effective in the unwinding direction, for example a spring-loaded arrangement, is provided, wherein, after the blocking device is released, the roller blind web is unwound by means of the drive means. It is obvious that, instead of an actuating push button or a different element which can be actuated by compressive force, an element which can be actuated by tensile force, such as a loop or the like, can also be provided, with locking and release taking place by application of a force in one actuating direction.

In one refinement of the invention, the linear guide means has at least one pivotable switch and the blocking device has at least one movable switching element for actuating the switch, the switch and the switching element interacting so as to arrest the linear guide means. By means of the switching element, the switch is pivoted for locking or release purposes. In one refinement, the switching element has an engagement surface for a user, with it being possible for the switching element to be pivoted and therefore the linear guide means to be arrested by application of a force to the engagement surface.

In a further refinement of the shading roller blind, the blocking device comprises a drive. In one refinement, the switching element can be moved by the drive in order to lock and/or release the lock. Since only a small actuating distance is required, the drive can be designed to be substantially more compact than a drive necessary over the entire length in order to wind up and/or unwind the roller blind web. In one refinement, the drive can be operated by remote control such that, for example, a shading or protective roller blind provided in the rear region can easily be wound up and/or unwound by a driver.

In a further refinement of the shading roller blind, the linear guide means comprises at least one rod which is operatively connected, for a transmission of movement, to a pull-out profile which is attached to the flexible sheetlike structure. The pull-out profile is preferably attached to a free border of the flexible sheetlike structure, with it being possible for it to be attached in a fixed or floating manner. The pull-out profile can extend over the entire width of the flexible sheetlike structure. The pull-out profile can be provided as a rod or the like, for example made of metal or plastic. In other refinements, the pull-out profile is realized integrally with the flexible sheetlike structure as a reinforcement.

In another refinement of the shading roller blind, the linear guide means comprises at least telescopic bar which is operatively connected, for the transmission of movement, to the pull-out profile which is attached to the flexible sheetlike structure. In one refinement, the telescopic bar is transferred by the spring-loaded arranged into an extended or a pushed-together position, with the telescopic bar requiring only a small amount of construction space in the pushed-together position.

Further advantages of the invention emerge from the description below of exemplary embodiments of the invention, which are illustrated schematically in the drawings. Standard reference numbers are used in the drawings for identical or similar components. All of the features and/or advantages, including method steps, structural details and spatial arrangements, which are revealed in the claims, the description or the drawings may be essential to the invention both by themselves and also in very varied combinations. Features described or illustrated as part of one exemplary embodiment can also be used in another exemplary embodiment in order to obtain a further embodiment of the invention.

In the drawings:

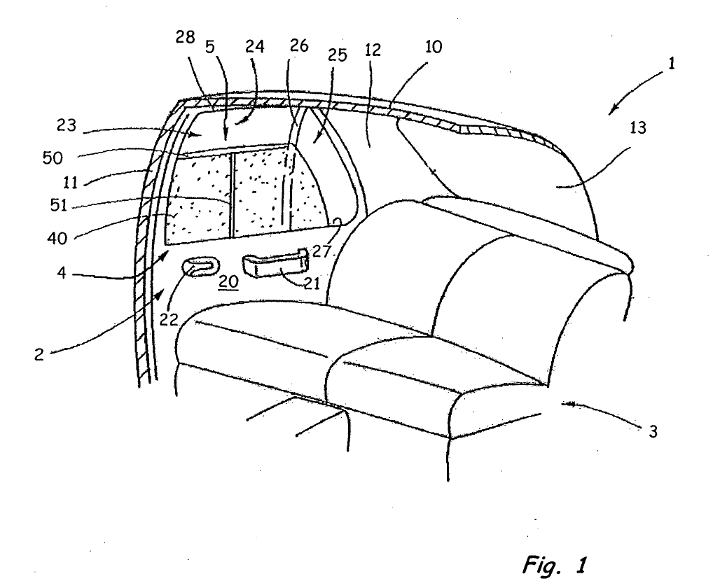

FIG. 1 shows a partially cutaway, perspective illustration of a rear region of a motor vehicle looking at the inside of the rear, right door;

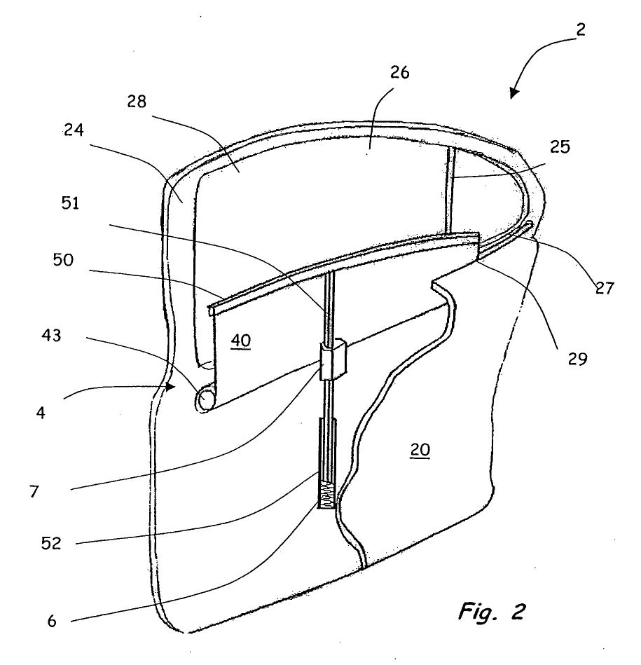

FIG. 2 shows the rear, right door according to FIG. 1 with a side window roller blind according to the invention according to a first exemplary embodiment, in a partially cutaway illustration;

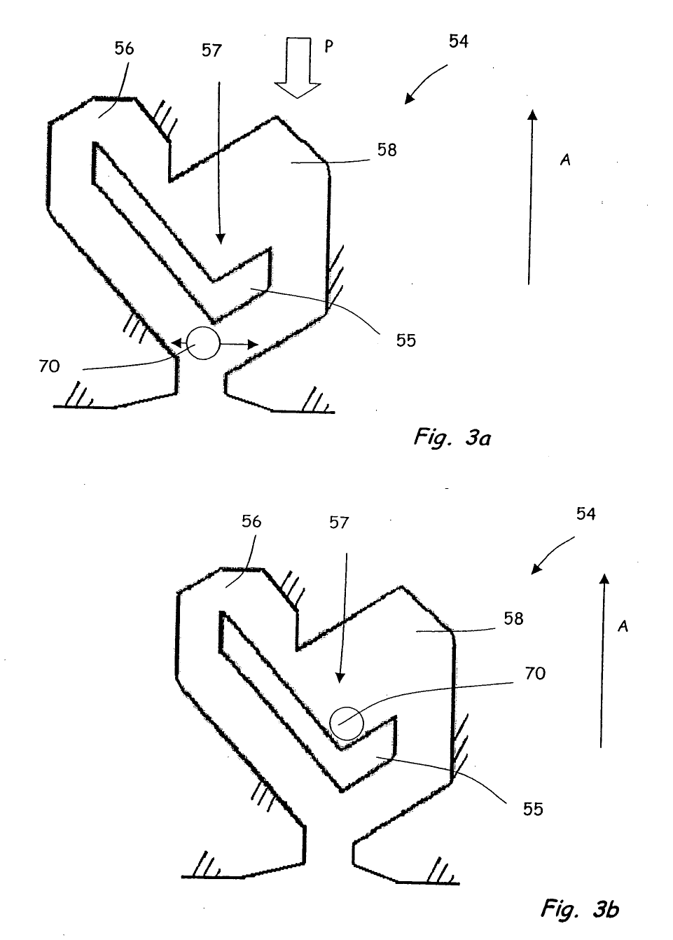

FIG. 3a shows a guide groove for a blocking device according to the invention with a latching element in a first functional position;

FIG. 3b shows the guide groove according to FIG. 3a with the latching element in a second functional position;

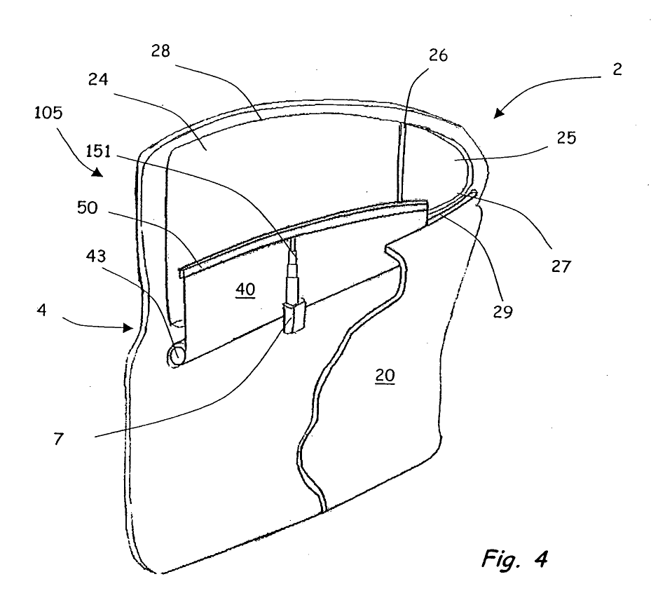

FIG. 4 shows the rear, right door according to FIG. 1 with a shading roller blind according to the invention according to a second exemplary embodiment, in a partially cutaway illustration;

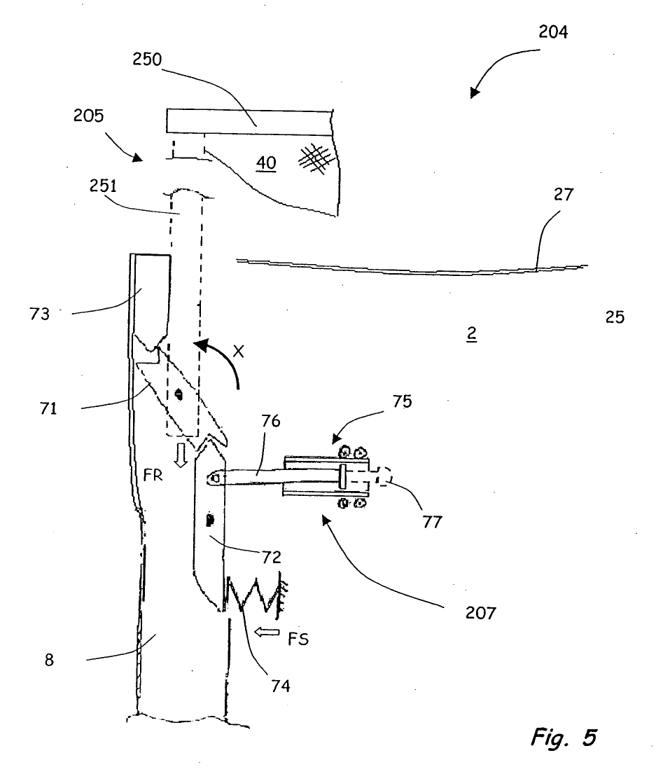

FIG. 5 shows a side window roller blind with a blocking device according to a third exemplary embodiment of the invention;

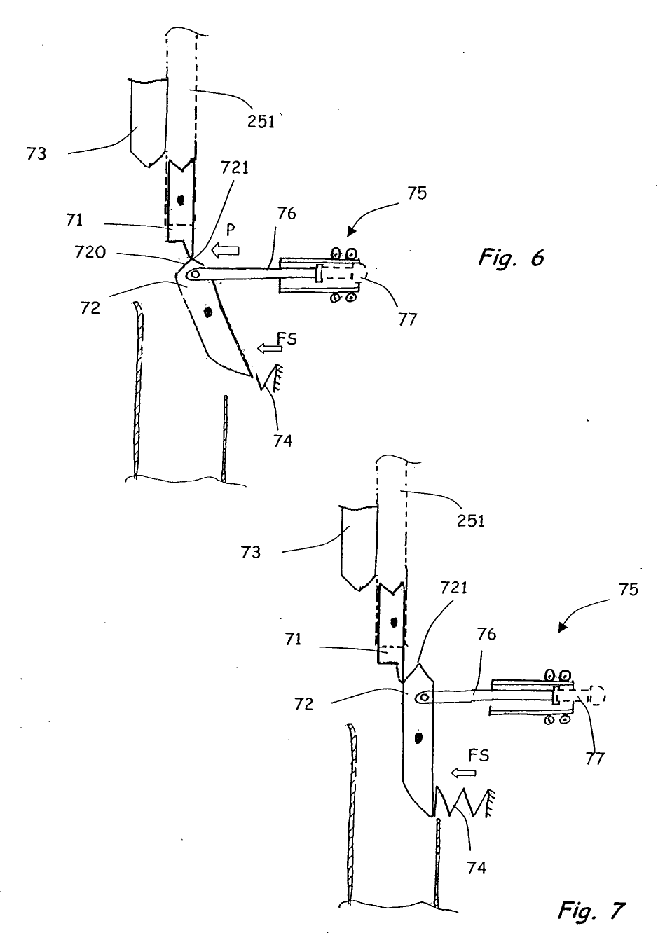

FIG. 6 shows a first operating state during an actuation of the blocking device according to FIG. 5;

FIG. 7 shows a second operating state during an actuation of the blocking device according to FIG. 5;

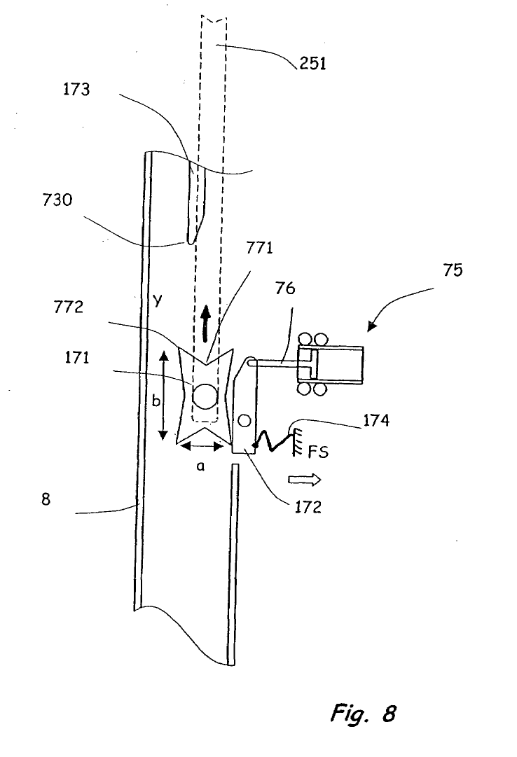

FIG. 8 shows a blocking device according to a fourth exemplary embodiment of the invention during the extension of a roller blind;

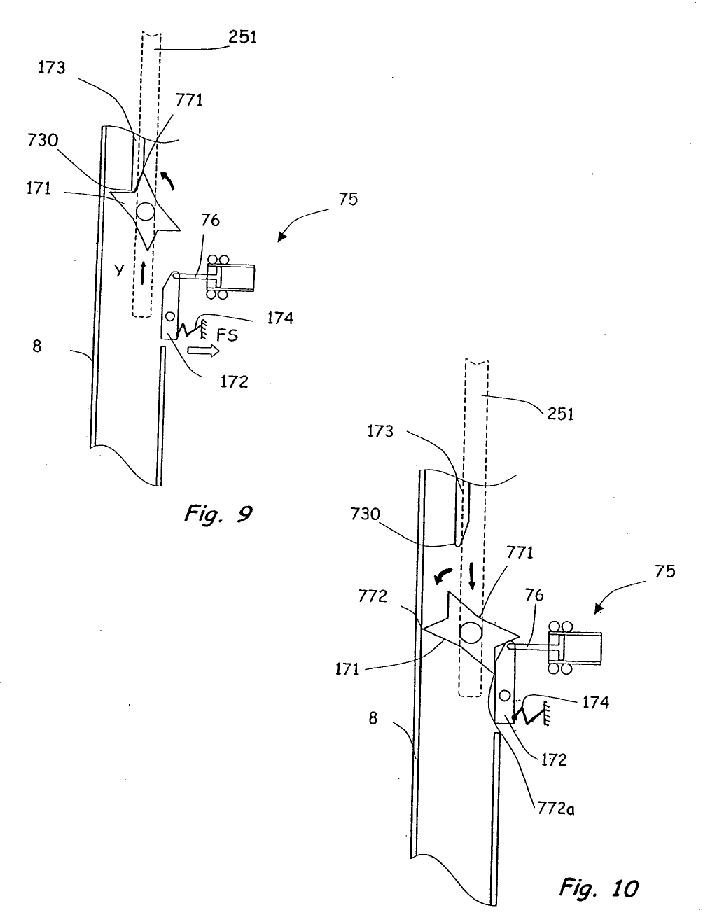

FIG. 9 shows the blocking device according to FIG. 8 when a switching point is reached;

FIG. 10 shows the blocking device according to FIG. 8 in a latched state;

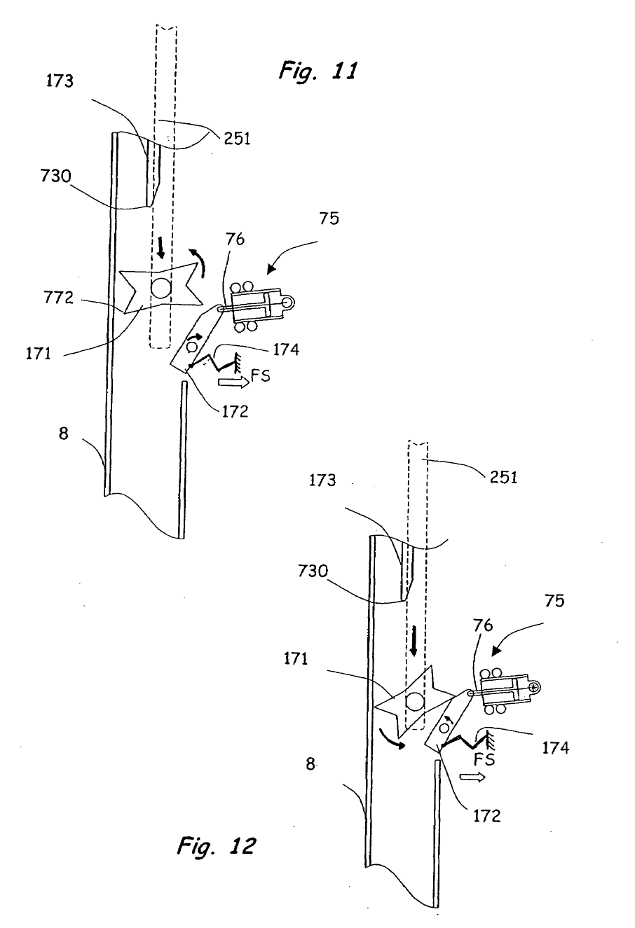

FIG. 11 shows the blocking device according to FIG. 8 when the latching connection is released, and

FIG. 12 shows the blocking device according to FIG. 8 upon retraction of the roller blind web.

FIG. 1 shows schematically a rear region of a motor vehicle 1 in a partially cutaway, perspective illustration looking at the inside of a rear, right side door 2. The motor vehicle 1 has a vehicle roof 10 from which a B pillar 11 of the motor vehicle 1 leads laterally to a floor assembly (not illustrated). As is known, a corresponding B pillar is also provided on the left side of the motor vehicle 1, which side is not illustrated in FIG. 1. The motor vehicle 1 illustrated furthermore has a C pillar 12. The roof 10 merges at a rear edge into a frame of a rear window opening 13 into which a rear window (not illustrated) can be inserted. The right, rear side door 2 is fitted in a known manner, for example by means of hinges (not illustrated), between the B pillar 11 and the C pillar 12. A rear seat bench 3 is located level with the side door 2.

The inside of the side door 2, which side is visible in FIG. 1 and faces an interior of the motor vehicle 1, has an inner trim panel 20. A door handle 21 and an actuating catch 22 for a door lock (not illustrated) are provided on the inner trim panel 20. Further elements (not illustrated), such as speakers and the like, can likewise be integrated in the side door 2 and/or attached thereto.

The side door 2 has a window opening 23 which is divided into a first section 24 and a second section 25 by means of a web 26. In this case, the second section 25 is designed as an opening for a “triangular window” such that the window opening 23 is essentially trapezoidal. The window opening 23 has a lower border 27 and an upper border 28, with the upper border 28 usually not running parallel to the lower border 27 but rather being able to have a curved profile. A two-part side window (not illustrated) can be inserted into the window opening 23. The side window can usually be displaced at least in the first section 24.

The window opening 23 can furthermore be darkened by means of a shading roller blind according to the invention which, in the exemplary embodiment, is designed as a side window roller blind 4 with a roller blind web 40. In other embodiments, a shading roller blind according to the invention serves to cover the rear window opening 13. In order to unwind the roller blind web 40 from a winding shaft (not illustrated in FIG. 1), the side window roller blind 4 illustrated comprises linear guide means 5 with a pull-out profile 50 and a rod 51. The pull-out profile 50 is attached to a free border of the roller blind web 40 and can be moved by means of the rod 51. As an alternative and/or in addition, the pull-out profile 50 is guided in lateral guide rails.

FIG. 2 shows schematically the side door 2 according to FIG. 1. Standard reference numbers are used for identical components and a detailed description of said components is omitted. In the illustration according to FIG. 2, the inner trim panel 20 of the side door 2 is partially cut away. As a result, parts of the side window roller blind 4 which are not visible during normal use can be seen. The side window roller blind 4 comprises a winding shaft 43 to which the roller blind web 40 is fastened in a manner such that it can be wound up and unwound. In the illustration according to FIG. 2, the roller blind web 40 is only partially unwound. As can be seen in FIG. 2, the roller blind web 40, as it is being wound onto the winding shaft 43, can be lowered behind the inner trim panel 20 of the side door 2 via a slot 29. In an advantageous refinement, the roller blind web 40 can be completely lowered behind the inner trim panel 20, but with the pull-out profile 50 protruding in a manner such that it is at least partially visible. The pull-out profile 50 illustrated is curved at least in some sections, and therefore the pull-out profile 50 can be matched to the profile of the upper border 28 of the window opening 23 to be covered. As a result, good darkening of the associated side window is possible, even in the border region.

The pull-out profile 50 is operatively connected to the rod 51 for displacing the pull-out profile 50 and therefore for unwinding the roller blind web 40 from the winding shaft 43. The rod 51 can be at least partially lowered in a hollow tube 52. The rod 51 and/or the hollow tube 52 require/requires little construction space on the side door 2 and thus can easily be integrated therein. During the lowering of the rod 51, a spring, for example a helical compression spring 6, is compressed. In this case, the helical compression spring 6 acts as a mechanical drive means, with an unwinding of the roller blind web 40 being able to take place on account of the spring force of the helical compression spring 6 and/or being assisted thereby. In other refinements, the pull-out profile is guided in one or two lateral guide rails, with it being possible for a spring for unwinding the roller blind web to be provided in the guide rail. In order to wind up the roller blind web 40 onto the winding shaft 43, a resetting spring (not illustrated) is preferably provided. In order to keep the roller blind web 40 in a certain position, a blocking device 7 is provided according to the invention. The blocking device 7 according to the invention comprises a push-push lock such that the rod 51 and/or the pull-out profile 50 can be arrested at least in a stowed position of the roller blind web 40, with it being possible for the arresting action to be released by pressing and/or moving said rod 51 and/or pull-out profile 50 counter to the unwinding direction. In the embodiment illustrated, the blocking device 7 interacts with the rod 51. For this purpose, the blocking device 7 in the exemplary embodiment illustrated comprises a latching element (not illustrated in FIG. 2) which interacts with the linear guide means 5 in a stowed position of the roller blind web 40 so as to arrest it.

FIGS. 3a and 3b schematically show a guide groove 54 of a push-push lock. The guide groove 54 or slotted guide is at least partially designed as cardioid. A latching element 70 which is arranged on the blocking device 7 according to FIG. 2 is guided in the guide groove 54. As illustrated by the arrows, the latching element 70 is mounted in the blocking device 7 in a manner such that it can be displaced in a direction transversely with respect to the unwinding direction A. The guide groove 54 is formed, for example, on the pull-out profile 50 or the rod 51 according to FIG. 2. For locking purposes, the pull-out profile 50 and/or the rod 51 and therefore the guide groove 54 are moved counter to the unwinding direction A, downward in the illustration, by application of a compressive force P. In the process, the latching element 70 is deflected by the slope of a mating latching element 55 formed in the guide groove 54, to the left in the embodiment illustrated. As soon as a reversing point 56 is reached, the force for moving the rod 51 and/or the pull-out profile 50 can be reduced, with the rod 51 and therefore the guide groove 54 being moved in the unwinding direction A, upward in the illustration, for example on account of the force of the helical compression spring 6 according to FIG. 2. As a result, the latching element 70 comes into engagement with the mating latching element 55 at a latching point 57. The latching element 70 here interacts with the mating latching element 55 in such a manner that the movement of the pull-out profile 50 and/or of the rod 51 in the unwinding direction A is prevented. By means of renewed movement of the rod 51 and/or of the pull-out profile 50 counter to the unwinding direction A, the guide groove is moved downward in the illustration and the latching element 70 is deflected laterally on account of the shape of the guide groove 54. In the exemplary embodiment illustrated, the deflection takes place to the right. Interaction of the latching element 70 with the mating latching element 55 is released as a result, as is therefore the blocking device 7 according to FIG. 2. After a reversing point 58 is reached, an actuating force can be removed, as a result of which the roller blind web 40 is extended, i.e. moved in the unwinding direction A, on account of the force of the helical compression spring 6.

FIG. 4 shows schematically the side door 2 according to FIG. 1 with a side window roller blind 4 according to a second exemplary embodiment of the invention. An actuating device 105 for the side window roller blind 4 comprises a telescopic bar 151 which acts on the pull-out profile 50 such that the pull-out profile 50 in the embodiment illustrated can be moved in the direction of the upper border 28 of the window opening 23 to unwind the roller blind web 40. The telescopic bar 151 illustrated is extended by means of a helical compression spring (not visible in FIG. 4) or the like. As can be seen in FIG. 4, a blocking device 7 according to the invention is likewise provided. The blocking device 7 here is designed in such a manner that the side window roller blind 4 can be unwound in a stepwise manner. If the roller blind web 40 is completely wound up on the winding shaft 43, then, upon an initial pressing and/or movement of the pull-out profile 50 and/or of the telescopic bar 151 counter to an unwinding direction, only a first segment of the telescopic bar 151 is extended. By means of renewed pressing at a little force and/or by means of movement of the pull-out profile 50 counter to the unwinding direction, a further segment of the telescopic bar 151 is extended. However, in other refinements, it is also conceivable for the telescopic bar 151 to be completely or continuously extended even when actuated for the first time, or for this to take place in steps independently of the segments.

FIG. 5 shows schematically a side window roller blind 204 according to a third exemplary embodiment of the invention. The side window roller blind 204 can be lowered level with a lower border 27 (indicated schematically) of a side door 2 (likewise only indicated schematically). A linear guide means 205 for the side window roller blind 204 comprises the pull-out profile 250, and a rod 251 or antenna arranged laterally on the roller blind web 40. The rod 251 is guided in a guide rail 8 at least in the region of the side door 2. The rod 251 and therefore the roller blind web 40 can be locked by means of a blocking device 207 in the position illustrated, this being the protective position of the roller blind web 40 in the exemplary embodiment illustrated. The blocking device 207 comprises a pivotable switch 71 which is attached pivotably to the rod 251, and a pivotable switching element 72 by means of which the switch 71 can be actuated. The width of the switch 71 is approximately equal to or smaller than the width of the rod 251, with it being possible for the switch 71 to be arranged in alignment with the rod 251 for the displacement of the rod 251. The switch 71 can furthermore be pivoted into the position illustrated, with a longitudinal axis of the switch 71 enclosing an angle with the longitudinal axis of the rod 251. In the arrangement illustrated in FIG. 5, the switch 71 is forced by a restoring force FR of the roller blind web 40, which restoring force acts downward in the illustration, in a direction shown by the arrow X. In the exemplary embodiment illustrated, a mating spring 74 is furthermore provided, said mating spring loading the switching element 72 and, as a result, forcing the switch 71 in the direction illustrated by the arrow X. In an oblique position of the switch 71 that is forced in such a manner, the switch 71 is held between the switching element 72 and a mating latching element 73 on the door such that a pivoting counter to the direction shown by the arrow X in order to align the switch 71 with the rod 251 is prevented.

The blocking device 207 illustrated furthermore comprises a drive 75 with a piston 76 by means of which the switching element 72 can be actuated. The drive 75 is configured, for example, with a servomotor such that a driver can actuate it remotely. As an alternative and/or in addition, an actuation push button 77 can be provided and can be used to actuate the switching element 72.

FIG. 6 and FIG. 7 schematically show an actuation of the blocking device 207 according to FIG. 5. As illustrated schematically in FIG. 6, a force P is applied by the servomotor 75 and/or the actuating push button 77, with the switching element 72 being actuated, pivoted in the embodiment illustrated, counter to the force FS of the mating spring 74. The switching element 72 interacts at its switching surface 720 with the switch 71 in such a manner that the switch 71 is pivoted such that the switch 71 is aligned with the rod 251. The switching element 72 is pivoted until it makes contact with the switch 71 at a reversing point 721, which is formed in the exemplary embodiment illustrated on the switching surface 720 by a tip of the switching element 72. When the force P is removed after the reversing point 721 is reached, the switch 71 is kept in the aligned arrangement by means of the switching element 72, as can be seen in FIG. 7, such that the rod 251 can be displaced and therefore the roller blind web can be wound up.

In a further refinement, the blocking device 207 blocks an unwinding of the roller blind web 40.

Remotely operated release and/or arrest of the blocking device 207 is possible by means of a drive 75, for example a servomotor and/or a solenoid. Only a small actuating distance is necessary and/or a small force has to be applied in each case to release and/or arrest it. Depending on the design of the drive means for the roller blind web 40, automatic unwinding, for example on account of a force of a spring-loaded arrangement, or automatic winding up, for example on account of a force of a restoring spring of the shading roller blind, takes place after the blocking device 207 is released.

FIGS. 8 to 12 schematically show an actuation of a blocking device 307. The blocking device 307 is designed in a similar manner to the blocking device 207 according to FIG. 5, and identical or similar reference numbers are used for identical or similar components.

The blocking device 307 comprises a pivotable switching head 171 which is attached pivotably to the rod 251 of the side window roller blind 204 according to FIG. 5. The switching head 171 has four concave corners 771 and four convex corners 772 which are arranged in a mutually alternating manner, with it being possible for a rectangle with a longitudinal side a and a broad side b to be formed by connection of the convex corners 772 of the switching head 171. The blocking device 307 furthermore comprises a pivotable switching component 172 which is attached to the vehicle and by means of which the switching head 171 can be actuated. The switching component 172 is subjected at one end to the force FS by means of a spring 174. A piston 76 of a retaining magnet 75 is attached to the opposite end, with the switching component 172 being pivotable about an axis arranged between the ends. In the exemplary embodiment illustrated, the retaining magnet 75 is unloaded in the position illustrated in FIG. 8.

In the arrangement of the switching head 171 that is illustrated in FIG. 8, the rod 251 and therefore the side window roller blind 204 can be extended out of the guide rail 8 in the direction indicated by the arrow Y. Extension is possible here until the switching head 171 reaches a mating latching element 173 provided on the guide rail 8; this position is also referred to as the switching point.

As illustrated in FIG. 9, the mating latching element 173 is arranged in such a manner that, when the switching point is reached, a tip 730 strikes against a flank of an upper concave corner 771 such that the switching head 171 is pivoted into a latching position. In the exemplary embodiment illustrated, pivoting takes place counter to the clockwise direction. Depending on the configuration of the spring 174, after the contact force between the switching component 172 and switching head 171 ceases, the switching component 172 can also be pivoted on account of the force FS of the spring 174. In the case illustrated, pivoting counterclockwise (not illustrated) would also be conceivable. In other configurations, the piston 76 is in the illustrated position on the stop, and therefore no further pivoting is possible.

As illustrated in FIG. 10, after the switching point is reached the side window roller blind 204 can be moved downward counter to the pull-out direction on account of gravitational force, for example by the pull-out force ceasing. In this case, the switching head 171 latches by means of two diagonally opposite, convex corners 772, 772a between a wall of the guide rail 8 and the switching component 172. In the exemplary embodiment illustrated, the switching component 172 is held in the position illustrated by means of the spring 174 and the switching head 172.

FIG. 11 shows the blocking device 307 when the latching connection is released. For this purpose, a force is applied by the retaining magnet 75 such that the switching component 172 is pivoted counter to the force FS of the spring 174. In the process, the switching head 171 is pivoted and/or displaced in such a manner that the latching connection is released. In other configurations, the spring 174 is designed in such a manner that it loads the switching component 172 in the clockwise direction, with a counterforce, which is reduced or removed in order to release the latching connection, being applied by the retaining magnet 75.

FIG. 12 shows the blocking device 307 upon retraction of the side window roller blind 204 after the latching connection is released, with the switching component 172 being pivoted back again after the force applied by the retaining magnet 75 ceases.

This locking and unlocking mechanism according to FIGS. 8 to 12 is likewise referred to as the push-push lock within the meaning of the invention. In this case, the force for the locking is applied to a broad side a of the switching head 171 and the force for the unlocking is applied to the longitudinal side b of the switching head 172, a brief application of force in each case bringing about locking or unlocking action.

In a further refinement, a blocking device according to FIGS. 8 to 12 can be used for the locking in a stowed position, wherein the elements are to be arranged in a manner reflected about a horizontal axis. In the exemplary embodiment illustrated, the movement from the switching position according to FIG. 9 into the latching position according to FIG. 10 takes place by means of the weight. The weight is also used for the latching according to FIG. 10. In the event of locking using a corresponding blocking device, a force corresponding to the effect of the weight can be applied by means of a spring, for example a spring-loaded arrangement for extending the roller blind.

1. Shading roller blind for a motor vehicle window, with a flexible sheetlike structure (40) which can be wound up on and unwound from a winding shaft (43) and can be moved with the aid of at least one linear guide means (5, 105) from a stowed position into an at least partially unwound protective position, and with at least one releasable blocking device (7, 207, 307) by means of which the linear guide means (5, 105) can be arrested in at least one position, characterized in that the blocking device (7, 207, 307) comprises a push-push lock.

2. Shading roller blind according to claim 1, characterized in that the linear guide means (5, 105) can be arrested in the stowed position, with it being possible for the blocking device (7) to be released by application of a force to the linear guide means and/or movement of the linear guide means counter to an unwinding direction (A).

3. Shading roller blind according to claim 2, characterized in that a mechanical drive means (6) which is effective in the unwinding direction (A) is provided, by means of which, after the b locking device (7) is released, the flexible sheetlike structure (40) can be unwound from the winding shaft (43).

4. Shading roller blind according to claim 3, characterized in that the mechanical drive means (6) is designed as a spring-loaded arrangement.

5. Shading roller blind according to claim 1, characterized in that the blocking device (7) comprises at least one latching element (70) which interacts with the linear guide means (5, 105) so as to arrest it.

6. Shading roller blind according to claim 5, characterized in that the linear guide means (5, 105) comprises a guide groove (54) in which the latching element (70) is guided, the guide groove (54) having at least one latching point (57).

7. Shading roller blind according to claim 6, characterized in that the guide groove (54) is in the shape of a cardioid at least in some sections.

8. Shading roller blind according to claim 1, characterized in that an actuating direction of the push-push lock runs transversely with respect to the unwinding direction (A), in particular at an angle of approx. 90°.

9. Shading roller blind according to claim 8, characterized in that the linear guide means (205) has a pivotable switch (71, 171) and the blocking device (207, 307) has at least one movable switching element (72, 172) for actuating the switch, the switch (71, 171) and the switching element (72, 172) interacting so as to arrest the linear guide means (205).

10. Shading roller blind according to claim 1, characterized in that the blocking device (7, 207, 307) comprises a drive, in particular a servomotor and/or a magnet.

11. Shading roller blind according to claim 1, characterized in that the linear guide means (5, 205) comprises at least one rod (51, 251) which is operatively connected, for a transmission of movement, to a pull-out profile (50, 250) which is attached to the flexible sheetlike structure (40).

12. Shading roller blind according to claim 1, characterized in that the linear guide means (105) comprises at least one telescopic bar (151) which is operatively connected, for the transmission of movement, to the pull-out profile (50) which is attached to the flexible sheetlike structure (40).
